(19) United States
(12) Patent Application Publication
(10) Pub. No.: US 2005/0147396 A1
(43) Pub. Date: Jul. 7, 2005

(54) Flexible storage of media information

(75) Inventor: Gerardus Cornelis Petrus Lokhoff, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/504,754

(22) PCT Filed: Jan. 21, 2003
(86) PCT No.: PCT/IB03/00216

(30) Foreign Application Priority Data
Feb. 20, 2002 (EP) 02075685.4

(51) Int. Cl. H04N 5/76

(52) U.S. Cl. 386/112; 386/111

(57) ABSTRACT

Items of media information are stored in separately reusable blocks of memory. Items are split into a plurality of layers, so that the item can be represented at reduced quality by a subset of the layers without using a remainder of the layers. Each layer is stored in a respective one of the blocks. When information of a subsequent item is stored, a block for storing the information of the second item dependent on a number of blocks that is in use for storing information. An unused block is selected when the number of blocks that is in use is below a threshold number. When the number is above the threshold number a block is re-used that was previously used for storing a layer from said remainder. Preferably, when the layers are encrypted, different layers of the first item are encrypted independently of one another, so that each layer can be decrypted even if the remainder has been overwritten.

The invention relates to a method of storing items of media information, a method of encrypting media information and a media information storage system.

Storage of media information, such as audio and video information requires a considerable amount of storage space. In storage systems such as disk systems, semiconductor memory, tapes etc., only a finite amount of storage space is available. However, the intrinsic property of media information is that it remains useful even if a certain amount of quality is sacrificed. To increase the amount of media information that can be stored in a storage system, the information is preferably compressed at the expense of quality. Many techniques have been developed to achieve a maximum compression ratio at the expense of a minimum loss of quality. Nevertheless, even with optimum techniques, the quality of the image will ultimately decrease with increased compression ratio.

European patent application No. 1001632 describes a compression apparatus that uses a variable compression ratio to manage the use of the available storage space. When storing incoming information, the compression ratio is adapted so as to ensure that an entire TV program fits into the available memory space. The adaptation of the compression rate is dynamical, less critical parts of the program being compressed more than more critical parts of the program. Weight information helps the system to forecast which parts are less critical and which are more critical, so that the compression ratio can be adapted accordingly.

A disadvantage of this system is that it requires foresight about the amount of information that is yet to come, and its required compression quality.

Amongst others, it is an object of the invention to provide for an efficient method of storage of media information and for a system for performing such storage in which no foresight is necessary to adapt the compression ratio to the available amount of storage space.

The method according to the invention is set forth in claim 1. According to the invention the media information is split into different layers, for example a series of layers with additional information of increasing detail in successive layers. Different layers for the same item (generally an interval of a TV program, such as a frame, or the like) are stored in separately reusable blocks of the memory system. Subsequently, when additional items of information are received and it turns out that insufficient memory space is available, memory can be made available by sacrificing the content of a memory block that contains a layer of an earlier item (e.g. a layer with additional details) that only contributes to increasing the quality with which this item can be recovered from memory. Thus, the quality of previously stored items can be reduced retroactively simply by sacrificing the content of blocks of memory.

The method is particularly suitable for a variable length compression system, in which the amount of storage space needed for the media information depends on the content of the media information. In such a system it is generally not predictable in advance how much storage space will be needed. By adapting the number of stored layers retroactively such a system can adapt to the content of the media information.

In an embodiment, the items are encrypted so that access to the items can be controlled, for example to prevent copyright infringement. Preferably, the layers of an item are encrypted separately, so that it remains possible to decrypt an item even when one or more layers of the item have been discarded. Thus, it is not necessary to decrypt the entire item and to re-encrypt it with a reduced number of layers when a number of layers is discarded.

Of course, the layers need not be encrypted for this purpose at the time of storage. The encryption of the individual layers may be performed separately, for example before transmission or transport of the media information to the storage system.

These and other objects and advantages of the method and system according to the invention will be disclosed in more detail using the following figures.

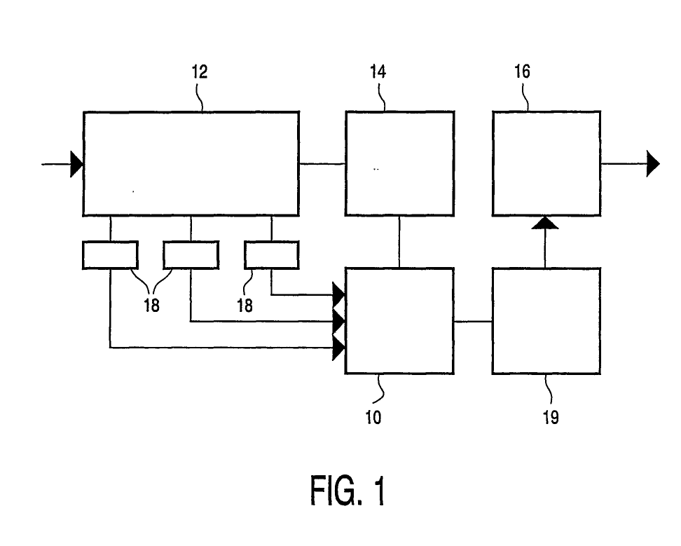

FIG. 1 shows a storage and retrieval system;

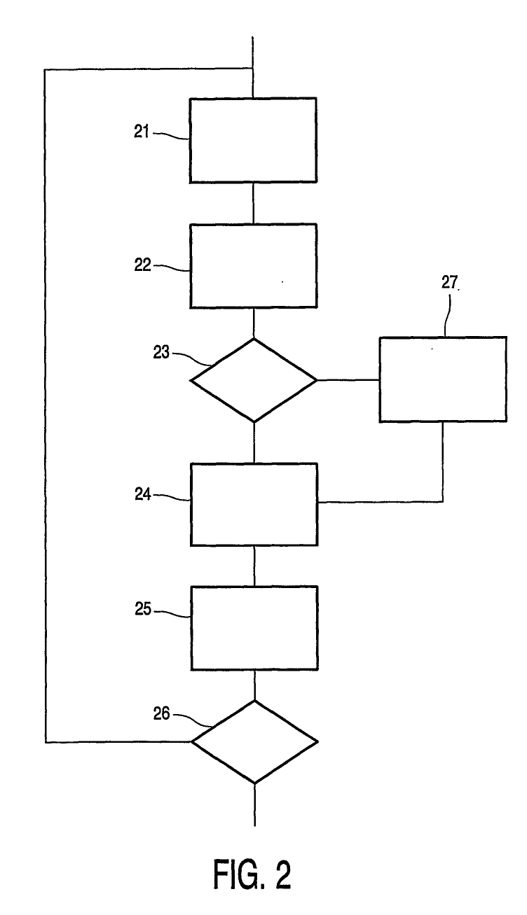

FIG. 2 shows a flow-chart of a method of storing information.

FIG. 1 shows a storage and retrieval system. The system contains a memory 10, a splitter 12, a memory management unit 14, a reconstruction unit 16, encryption units 18 and a decryption unit 19. The splitter 12 has an input for receiving media information, outputs for outputting layers of information to memory 10 via encryption units 18 and connection with memory management unit 14. Memory management unit 14 has an output coupled to memory 10. Reconstruction unit has an input coupled to memory 10 via decryption unit 19.

FIG. 2 shows a flow chart of the operation of the system of FIG. 1. In a first step 21, splitter 12 receives items from a stream of media information. The media information is for example video information and/or audio information, or more generally any type of information that can be compressed with a gradually increasing loss of quality as more compression is used. In the case of video information, the incoming media information is for example in MPEG format, encoded in terms of a number of DCT (Digital Cosine Transform) coefficients, or in terms of a set of numbers that represent the values of individual pixels. In case of audio, the media information is encoded for example by a number of sample values (in PCM format) or by some compressed information, such as sample values of the signal from different frequency bands. The items may represent individual frames, image blocks or time intervals of the media information, different television programs etc.

In a second step 22, splitter 12 splits the item into a number of layers, if necessary after compression. The layers may be viewed as a succession of layers, each adding information to the information of the preceding layers, so that the item can be reconstructed with increasing accuracy by using more layers of the succession.

In one example, DCT coefficients for different spatial frequency components of an image are encoded in different layers, so that low frequency components are encoded in a first frequency components are encoded in a second layer. Thus, by using only the first layer to recover the item, one would get a low frequency (low spatial resolution) version of the image. The different coefficients may be obtained for example by computing a DCT of an image block, or they may be taken from an MPEG signal, which encodes different DCT coefficients. In another embodiment, bits of different significance levels from numbers that represent samples of the signal are placed in different layers. In addition to the split into layers, the second step 22 may also include compression of the item, for example loss-less compression and/or variable length compression which produces a variable amount of information in each layer, dependent on the content of the item.

In another example, a first layer contains data representing sample values of a subsampled version of an image, a second layer containing information about the difference between the subsampled version of the image and the image itself. Of course this could be repeated by placing sample values of increasingly less subsampled versions of the image in successive layers. In yet another example different layers contain I-frames and B or P-frames of encoded MPEG images respectively.

Preferably, encryption units 18 encrypt the various layers, each independently from the other layers for the same item, in the sense that the different layers can be decrypted in the absence of other layers. It will be appreciated that, although different encryption units 18 are shown to emphasize the independence of encryption of the different layers, in practice a single encryption unit may be used to encrypt each of the layers.

In a third step 23, splitter 12 signals to memory management unit 14 how many blocks from memory 10 are needed to store the layers for the item. Memory management unit 14 determines whether sufficient unused blocks are available. If so, a fourth step 24 is executed, in which memory management unit 14 selects a number of blocks from memory 10 for storage of the respective layers. Memory management unit 14 stores information indicating which type of layer (e.g. the position of the layer-in the succession of the layers in order of increasing detail) is stored in which block. In a fifth step 25 splitter 12 stores the layers for the item in memory 10. In a sixth step splitter 12 determines whether a new item has arrived and if so the process repeats from the first step 21.

After the third step 23, if memory management unit 14 has determined that insufficient memory is available, memory management unit 14 executes a seventh step 27, selecting a number of memory blocks for reuse. These memory blocks are already in use for layers from preceding items. These memory blocks are selected according to the information that indicates which type of layer is stored in the blocks. Generally, blocks are selected that store layers which add the least amount of quality to the items they represent. For example, using the succession of layers with additional information that adds to layers that precede the layer in the succession, the layers at the end of the succession (that add the last additional information) are selected. The selected memory blocks are marked as unused, thus effectively discarding the layers stored in those blocks. Subsequently the process continues from the fourth step, i.e. the selection of unused memory blocks for storage of the layers produced by the splitter 12. In an embodiment, the memory management unit 14 may also signal to splitter 12 that some of the less important layers of the present item may not be stored, so that less stored layers need to be discarded.

Subsequently, or concurrently, reconstruction unit 16 reads the layers from the memory 10 and reconstructs the items, as far as possible, from the layers that have been stored and retained in the memory 10. The quality with which reconstruction unit can reconstruct the items depends on the number of layers that have been retained. For example, less detail may be present in reconstructed images, as layers with finer details have been discarded. The reconstruction unit 16 may for example contain a display screen (not shown) to display the images encoded by the items and/or a loudspeaker to output sound encoded by the items. But the reconstruction unit 16 may also have an output to transmit the retrieved information via a communication channel.

If necessary, decryption unit 19 is used to decrypt the layers. Because the layers have been encrypted independently, they can be decrypted even if some of the less important layers have been discarded.

It will be appreciated that numerous changes can be made to the embodiment without deviating from the invention. For example, instead of using a separate splitter 12, memory management unit 14 and reconstruction unit 16, one or more of these functions may be combined and/or performed using a suitably programmed general purpose processor. The memory 10 may in fact comprise a set of different memory-devices, different layers or different items being stored in different devices. Additional memory may be present, for example, the memory 10 may have a cache memory function to speed up a larger main memory (not shown). In this case, layers are discarded to reuse their cache memory blocks, but the main memory may retain the discarded layers. Thus, in this case, the cache replacement strategy is based on layer number of information representing items of media information rather than on parameters such as most recent use. The memory may be implemented in any way that allows reuse of memory blocks, for example as a semiconductor memory, for example a DRAM or a flash memory, magnetic or optical disk, tape etc.

Various strategies may be used in the third step 23 and seventh step 27 to decide when and how to discard layers. For example, in a first embodiment, the memory management unit 14 may store a predetermined threshold value of freely available memory blocks in memory 10. In this embodiment memory management unit 14 also counts how many blocks are in use for stored information. Once the result of this count exceeds the threshold, memory management unit 14 proceeds with the seventh step 27. But there are many alternatives to this scheme. For example, the threshold might be set individually for storing specific television programs, or more generally media files, so that a maximum amount of storage is allocated to each program separately. This allows a more refined control over memory usage. The threshold might be set equal to total memory capacity, so that reuse occurs only when the memory is full, or the threshold might be set lower that this total, so that always some memory space remains available. Comparison with the threshold need not be related to storage of new items, but it might be performed only periodically so as to create sufficient usable memory space for the maximum possible amount of information to may have to be stored in a period of time.

Similarly, in the seventh step 27, selection of layers that are to be discarded may be performed in many ways. In principle any random selection of layers that add least to quality may be performed. However, in an embodiment weight values may be assigned to different layers, for example according to layer position in the series of layers that represents an item, importance of the item (as indicated for example by the source of the item, or by the user of the system), expected use of the item etc. In this case the layers with minimum weight are discarded first. That is, the weight according to layer position, which is the basis for selectively discarding layers the same item, may be differentiated for different items according to a weight assigned to the item.

It will be clear that, although a illustrative embodiment of the storage system has been shown, the invention is not limited to that embodiment. For example, instead of using a separate splitter 12, management unit 14 and encryption unit 18, one ore more of these units may be combined and/or their function may be implemented using a suitably programmed computer. In that case, a program carrier such as a CD-ROM or an internet signal may be used for example to enter the required program into the computer. Also, although splitting and reconstruction are shown to be performed by components of the same system, it will be appreciated that the writing side 10, 12, 14, 18 of the system and the reading side 16, 19 may be both part of a single apparatus, or part of different apparatuses, the memory 10 being used as an intermediary in the transport of information between the apparatuses.

1. A method of storing items of media information in a storage system that contains separately reusable blocks of memory (10), the method comprising
splitting the information of a first item into a plurality of layers, so that the first item can be represented at reduced quality by a subset of the layers without using a remainder of the layers;
storing each layer in a respective one of the blocks;
storing information of a second item subsequently to storing information of the first item;
selecting a block for storing the information of the second item dependent on a number of blocks that is in use for storing information, an unused block being selected when the number of blocks that is in use is below a threshold number, a block used for storing a layer from said remainder being re-used for storing the information of the second item if the number is above the threshold number.

2. A method according to claim 1, wherein the media information is visual information, the subset and the remainder of the layers containing a low resolution part and a remainder of the visual information respectively.

3. A method according to claim 1, comprising encrypting the items of media information, different layers of the first item being encrypted independently of one another.

4. A method of encrypting media information, the method comprising splitting the information into a plurality of layers so that the media information can be represented at reduced quality by a subset of the layers without using a remainder of the layers, the layers being encrypted independently of one another.

5. A media information storage system, comprising
splitting means (12), for splitting items of received media information into a plurality of layers so that the media information can be represented at reduced quality by a subset of the layers without using a remainder of the layers;
separately reusable blocks memory (10);
a memory management system (14) for assigning blocks to respective layers of respective items, the memory management system (14) being arranged to select to store layers of information of a second one of the items either in freely available ones of the blocks or in blocks in use for the remainder of the layers of a first one of the items, said selection being dependent on a number of blocks that is freely available, so that freely available ones of the blocks are selected when more than a threshold number of blocks is freely available.

6. A media information storage system according to claim 5, comprising encryption circuitry (18) arranged to encrypt different ones of the layers for the first one of the items independently of one another.

7. A computer program product containing instructions for causing a computer to execute the method according to claim 1.
